(19) United States
(12) Patent Application Publication
(10) Pub. No.: US 2018/0192677 A1
(43) Pub. Date: Jul. 12, 2018

(54) EDIBLE COMPOSITIONS CONTAINING STABILIZED NATURAL COLORANTS

(71) Applicant: WM. WRIGLEY JR. COMPANY, Chicago, IL (US)

(72) Inventors: Penny MARTIN, Chicago, IL (US); Christine JILEK, Chicago, IL (US); Lilian RAMIREZ, Chicago, IL (US)

(21) Appl. No.: 15/740,663

(22) PCT Filed: Jun. 29, 2016
(86) PCT No.: PCT/US2016/040169

§ 371 Date: Dec. 28, 2017

Related U.S. Application Data
(60) Provisional application No. 62/186,980, filed on Jun. 30, 2015.

(51) Int. Cl. A23L 5/44; A23L 5/43; A23L 33/105; A23G 4/06

(52) U.S. Cl. CPC A23L 5/44; A23L 5/43; A23V 2002/00; A23G 4/068; A23L 33/105

(57) ABSTRACT

The present disclosure generally relates to edible compositions comprising naturally derived food colorants, and more specifically to edible compositions comprising naturally derived food colorants and a stability enhancing isoquercitrin anti-oxidant. A claim is directed to an edible composition comprising from about 0.0005 to about 3 percent by weight of a natural colorant; and from about 0.015 to about 0.15 percent by weight of enzymatically modified isoquercitrin antioxidant. The natural colorant is preferably selected from carotenoid, curcumin, anthocyanins, betanin, gardenia blue, gardenia yellow, chlorophyllins, phycocyanins and combinations thereof.

### FIELD OF THE DISCLOSURE

The present disclosure generally relates to edible compositions comprising naturally derived food colorants, and more specifically to edible compositions comprising naturally derived food colorants and a stability enhancing isoquercitrin anti-oxidant.

### BACKGROUND OF THE DISCLOSURE

The use of artificial and synthetic colors and dyes in edible compositions has come under increased scrutiny due concerns related to toxicity and certain metabolic disorders. For instance, it has been alleged that Red #40 is associated with hyperactivity and ADHD in children, and the safety of many other such colors and dyes has been called into question. For those reasons, the use of artificial colors and dyes is being phased out of many edible compositions. As used herein, edible compositions include solid or semi-solid comestibles such as, without limitation, chewing gum, confectionaries (e.g., hard candy, mints and toffee), food products (e.g., cereal and cookies) and powders (e.g., flavoring powders and gelatins). Beverages (e.g., soda and fruit juice) are not within the scope of edible compositions of the present disclosure.

Nonetheless, manufacturers and consumers desire edible products having vibrant and appealing color. For this reason, natural colorants are finding increasing use as replacements for artificial colors and dyes. However, natural colorants are typically unstable and degrade over time upon exposure to heat, moisture, high or low pH, oxygen, and UV light. The result is color fade or color change.

A need therefore exits for compositions and methods for improving the stability of naturally derived food colorants.

### BRIEF DESCRIPTION OF THE DISCLOSURE

In some aspects of the disclosure, an edible composition, such as a sugarless chewing gum composition, is provided. The composition comprises (1) from 0.0005 to about 3 percent by weight of a natural colorant; and (2) from about 0.015 to about 0.15 percent by weight of enzymatically modified isoquercitrin anti-oxidant.

In some other aspects of the disclosure, an edible composition, such as a sugarless chewing gum composition, is provided. The composition comprises a natural colorant and enzymatically modified isoquercitrin wherein the color stability is enhanced as compared to a similarly formulated control composition differing with respect to the absence of an anti-oxidant, and wherein the color stability is determined visually by comparison of color intensity or color shift wherein instability is indicated by a reduction in color intensity, by a color shift, or by a combination thereof.

In other aspects of the disclosure, a method for preparing a sugarless chewing gum composition is provided. The method comprises: (1) forming a premix comprising a natural colorant and enzymatically modified isoquercitrin anti-oxidant; (2) combining the premix with a water soluble bulk portion, a water-insoluble base portion, a sweetener portion, and a flavoring portion; and (3) admixing the components to form the sugarless gum composition.

### BRIEF DESCRIPTION OF THE DRAWINGS

FIG. 1 depicts the results for stability analysis for two sugarless gum compositions of the present disclosure comprising black carrot natural (non-artificial) color and enzymatically modified isoquercitrin (EMIQ) anti-oxidant and for a similarly formulated sugarless gum composition not containing the anti-oxidant.

FIG. 2 depicts the results for stability analysis for two sugarless gum compositions of the present disclosure comprising red beet natural (non-artificial) color and enzymatically modified isoquercitrin (EMIQ) anti-oxidant and for a similarly formulated sugarless gum composition not containing the anti-oxidant.

### DETAILED DESCRIPTION

The present disclosure is directed to edible compositions comprising a naturally derived food colorant (also referred to herein as “a natural colorant” or “a natural sourced color” or a “naturally derived colorant”) that is stabilized with a rutin and/or isoquercitrin compound. More particularly, in accordance with the present disclosure it has been discovered that naturally derived food colorants, including natural sourced colors derived from living organisms (including plants, invertebrates, animals, or other natural sources) may be stabilized in edible food compositions by co-formulation with an anti-oxidant selected from rutin, isoquercitrin, enzymatically modified rutin, enzymatically decomposed rutin (quercetin), enzymatically modified isoquercitrin, isoquercitrin, and combinations thereof.

### I. NATURALLY DERIVED FOOD COLORANT AND RUTIN/ISOQUERCITRIN ANTIOXIDANT

In some aspects, the naturally derived food colorant is derived from a living organism, such as a plant, an animal, or an invertebrate. In some aspects, the natural sourced color is derived from biosynthesis. In some aspects, the colors may be provided as extracts from living organisms.

In some aspects, the naturally derived food colorant is an extract from a living organism, such as a plant, animal, insect, and the like. For example, in some aspects, the naturally derived food colorant comprises an extract obtained from an animal, an insect, or a plant, and any combination thereof. Plant-sourced colors may be derived from roots, berries, bark, leaves, seeds, grain, fruit, stems, and wood. Microbial sources of naturally derived food colorants include algae, yeast, and bacteria. Extracts may provide a composition comprising a range of colorant compounds and other compounds. For example, extracts may be selected from and/or sourced from carotenoid (e.g., carotene, 3-Apo-8′-carotenal and ethyl ester of (3-Apo-8′-carotenoic acid), curcumin, anthocyanins (e.g., black carrot and purple carrot), betanin (e.g., beetroot red and dehydrated beets), Gardenia (e.g., blue and yellow), chlorophyllins (e.g., chlorophyll), phycocyanins (e.g., phycocyanobilin), sweet potato, cochineal, elderberry, turmeric, paprika, grapeskin, annatto, red cabbage, Carthamus yellow, purple sweet potato, purple corn, monascus (e.g., monascin, monascorubin, monascorubramine, rubropunctatin and rubropunctamine), carnitine, crocin, saffron, gardenia yellow, Huito blue/watermelon, Melanins, Iridophores, Phyoerythrin, fruit juice, vegetable juice, saffron, lutein, carminic acid, carmine, laccaic acid, lycopene, riboflavin, ankaflavin, caramel, bixin, norbixin, canthaxanthin, capsanthin, geniposide, genipin, and combinations thereof. In some aspects, the naturally derived food colorant is selected from carotenoid, curcumin, black carrot, beet, gardenia blue, gardenia yellow, chlorophyllins, phycocyanins and combinations thereof.

In any of the various aspects of the present disclosure, the concentration of the naturally derived food colorant in the edible compositions may be about 0.0005 percent by weight (wt. %), about 0.01 wt. %, about 0.1 wt. %, about 0.5 wt. %, about 1 wt. %, about 1.5 wt. %, about 2 wt. %, about 2.5 wt. % or about 3 wt. %, and ranges thereof, such as from about from about 0.0005 wt. % to about 3 wt. %, or from about 0.0005 wt. % to about 0.1 wt. %, or from about 0.01 wt. % to about 3 wt. %. In some embodiments, the edible composition is a chewing gum, wherein the concentration of the naturally derived colorant in the gum is from about 0.01 wt. % to about 3 wt. %

In some aspects, the anti-oxidant compound may comprise, essentially consist of, or consist of enzymatically modified rutin, enzymatically decomposed rutin (quercetin), enzymatically modified isoquercitrin, isoquercitrin and combinations thereof. Enzymatically modified isoquercitrin is available commercially as SANMELIN™, such as SANMELIN AO-1007 or SANMELIN AO-3000 (available from San-Ei Gen F.F.I., Inc.). In any of the various aspects of the disclosure, the concentration of the anti-oxidant (e.g., enzymatically modified isoquercitrin) in the edible food composition may be about 0.015 wt. %, about 0.03 wt. %, about 0.045 wt. %, about 0.06 wt. %, about 0.075 wt. %, about 0.09 wt. %, about 0.105 wt. %, about 0.12 wt. %, about 0.135 wt. % or about 0.15 wt. %, less than 0.15 wt. %, and ranges thereof, such as from about 0.015 wt. % to about 0.15 wt. %, between 0.015 wt. % and 0.15 wt. %, from about 0.075 wt. % to about 0.15 wt. % or between 0.075 wt. % and 0.15 wt. %.

In some aspects of the disclosure the weight ratio of natural colorant to rutin/isoquercitrin, such as enzymatically modified isoquercitrin, in the edible composition is suitably about 200:1, about 100:1, about 50:1, about 25:1, about 10:1, about 8:1, about 6:1, about 4:1, about 2:1, about 1:1 or about 1:1.5, and ranges thereof, such as from about 200:1 to about 1:1.5, from about 100:1 to about 1:1.5, from about 50:1 to about 1:1.5, from about 25:1 to about 1:1.5, from about 25:1 to about 1:1, from about 10:1 to about 1:1, or from about 10:1 to about 2:1. In some such embodiments, the edible composition is a chewing gum.

The naturally derived food colorant and anti-oxidant (enzymatically modified rutin, enzymatically decomposed rutin, enzymatically modified isoquercitrin and/or isoquercitrin) may be combined by various means. For instance, in some aspects, a pre-blend is formed from said anti-oxidant and the naturally derived food colorant. The pre-blend may optionally be formulated with the food product sweetener (as described in more detail herein). For instance, in the case of sugarless gum (as described in more detail herein), the pre-blend may be combined with polyol syrup and then mixed with the gum base. In some other aspects, said food colorant and anti-oxidant may be individually added to the gum base along with the sweeter prior to admixing.

In some optional aspects, the naturally derived food colorant (granular or liquid) and rutin/isoquercitrin anti-oxidant (liquid) may be admixed or dispersed with one or more liquid or solid components such as bulk sweeteners, softeners, emulsifiers and fillers to form a master-batch for formulation into edible compositions. For instance, in some aspects, the rutin/isoquercitrin anti-oxidant may be dispersed with glycerol, ethanol, naturally derived food colorant, and combinations thereof. In some embodiments, the naturally derived food colorant and rutin/isoquercitrin anti-oxidant may be admixed or dispersed in a confectionery coating.

In any of the various aspects of the present disclosure, stability of the naturally derived food colorant may be achieved in the absence of polysaccharides and oligosaccharides known in the art as stabilizers. Examples of such as polysaccharides and oligosaccharides include nigerooligosaccharide, maltooligosaccharide and panose. Thus, in certain embodiments, the compositions of the present disclosure are characterized by the essential absence of polysaccharides and oligosaccharides, meaning that the compositions do not contain any, or contain such a low amount of poly- or oligosaccharide that the poly- or oligosaccharide does not provide any colorant stabilizing effect.

### II. EDIBLE COMPOSITIONS

Edible compositions within the scope of the present disclosure include, without limitation, chewing gums (e.g., tablet gums, pellet or dragee gums, stick gums, compressed gums, co-extruded layered gums, bubble gums, etc.), confections (e.g., candies, chocolates, gels, confectionery pastes, etc.), and food products (e.g., cookies, breakfast cereals, cheeses, etc.). As used herein, the term “edible composition” does not include beverages, such as soda and fruit juice, but does include certain flowable compositions, such as syrups. In some embodiments, the composition is a confectionery composition in the form of a coating, shell, film syrup, or suspension. Such delivery systems are well known to one of skill in the art, and preparation generally entails forming a premix comprising the natural colorant and the anti-oxidant, combining the premix with a warm base with flavor and sweeteners, and admixing the components to form the edible composition. Non-limiting examples of edible compositions include sugarless chewing gum, sugar-containing chewing gum, hard candies, chewy candies or confections, fruit snacks, fruit leathers, caramels, toffee, fudge, lozenges, tablets, candied fruit, soft coatings, hard coatings, cookies, breakfast cereal, icing, syrup, hard cheese and powders (e.g., chocolate powder, gelatins, flavoring powders). In some aspects, the edible composition is sugarless chewing gum.

In some aspects of the disclosure, edible compositions may be defined as having a water activity of less than 0.9. Water activity (aw) is a measure of the energy status of the water in a system. Water activity may alternatively be defined as:

a_{w}=p/p₀ where p is the vapor pressure of water in the substance, and p₀ is the vapor pressure of pure water at the same temperature; and

a_{w}=l_{w}/x_{w} where l_{w} is the activity coefficient of water and x_{w} is the mole fraction of water in the aqueous fraction.

Water activity varies from 0 (absolute dryness) to 1 (100% relative humidity). Water activity and moisture content are inter-related with the relationship at a given temperature termed the moisture sorption isotherm wherein the moisture sorption isotherm varies from composition-to-composition due to interactions, such as colligative, capillary and surface effects, between water and solid components (see Bell and Labuza, Moisture Sorption-Practical Aspects of Isotherm Measurement and Use (2nd Ed.), American Association of Cereal Chemists, Inc. St. Paul, Minn. (2000)). Generally, a_{w} is positively and non-linearly correlated to water content. Higher a_{w} substances tend to support more microorganisms. Bacteria usually require at least 0.91, and fungi at least 0.7. Typical a_{w} values are listed in the Table 1 below.

TABLE 1

| Substance | a_{w} | Moisture % |
|---|---|---|
| Distilled Water | 1.00 | 100% |
| Tap Water | 0.99 | Essentially 100% |
| Fruit Juice | 0.97 | 80% to 95% |
| Carbonated Soda | 0.98 | 85% to 90% |
| Carbonated Diet Soda | 0.99 | Essentially 100% |
| Candied Fruit | 0.60 | 20% to 30% |
| Honey | 0.5 to 0.7 | 15% to 25% |
| Caramels, Toffees and Fudge | 0.45 to 0.6 | 6% to 10% |
| Chewing Gum | 0.4 to 0.65 | 3% to 6% |
| Hard and Chewy Candies | 0.4 to 0.7 | 1% to 15% |
| Fruit Snacks and Leathers | 0.5 to 0.65 | 4% to 20% |
| Milk Chocolate | 0.4 to 0.6 | 1% to 10% |
| Soft Coating | 0.4 to 0.65 | 3% to 6% |
| Hard Coating | 0.4 to 0.75 | 0% to 1% |
| Lozenges and Tablets | 0.4 to 0.75 | 0% to 1% |
| Cookies | 0.2 to 0.65 | 2.5% to 12% |
| Breakfast Cereal | 0.2 to 0.5 | 1% to 8% |
| Icing | 0.75 to 0.85 | 10% to 20% |
| Syrup | 0.6 to 0.85 | 20% to 30% |
| Hard Cheese | 0.7 to 0.9 | 30% to 40% |
| Soft Cheese | 0.9 to 0.95 | 40% to 55% |
| Powders (chocolate powder, | 0.15 to 0.3 | 1% to 10% |
| gelatins, flavoring powders) | | |

In any of the various such aspects, a_{w} is less than 0.9, less than 0.8, about 0.1, about 0.2, about 0.3, about 0.4, about 0.5, about 0.6, about 0.7, or about 0.8, and ranges thereof, such as from about 0.1 to about 0.8, or from about 0.2 to about 0.7. In some aspects, the water content is about 1 wt. %, about 5 wt. %, about 10 wt. %, about 20 wt. %, about 30 wt. %, about 40 wt. %, or about 50 wt. %, and ranges thereof, such as from about 1 to about 50 percent by weight, from about 1 to about 40 percent by weight, from about 1 to about 30 percent by weight, from about 1 to about 20 percent by weight, or from about 1 to about 10 percent by weight.

### III. CHEWING GUM

In some aspects of the present disclosure, the edible composition is chewing gum. In general, a chewing gum composition typically comprises a water-soluble bulk portion, a water-insoluble chewable gum base portion and typically water-soluble flavoring agents. The water-soluble bulk portion dissipates with a portion of the flavoring agent over a period of time during chewing. The gum base portion is retained in the mouth throughout the chew.

The insoluble gum base generally comprises one or more of elastomers, elastomer plasticizers, solvents, waxes, resins, fats and oils, softeners and inorganic fillers. The insoluble gum base can comprise from about 5 wt. % to about 95 wt. %, from about 10 wt. % to about 50 wt. % or from about 25 wt. % to about 35 wt. % by weight, of the chewing gum.

The elastomers (rubbers) employed in the gum base may vary greatly depending upon various factors such as the type of gum base desired, the consistency of gum composition desired and the other components used in the composition to make the final chewing gum product. The elastomer may be any water-insoluble polymer known in the art, and includes those gum polymers utilized for chewing gums and bubble gums. Illustrative examples of suitable polymers in gum bases include both natural and synthetic elastomers.

The amount of elastomer employed in the gum base may vary depending upon various factors such as the type of gum base used, the consistency of the gum composition desired and the other components used in the composition to make the final chewing gum product. In general, the elastomer will be present in the gum base in an amount from about 10 wt. % to about 60 wt. % or from about 35 wt. % to about 40 wt. %. In some aspects of the disclosure, the chewing gum base comprises from about 20 wt. % to about 60 wt. % synthetic elastomer and up to 30 wt. % by weight natural elastomer, or from about 5 wt. % to about 55 wt. % by weight elastomer plasticizer.

Synthetic elastomers may include, but are not limited to, polyisobutylene (e.g., with GPC weight average molecular weight of about 10,000 to about 95,000), isobutylene-isoprene copolymer (butyl elastomer), styrenecopolymers (e.g., having styrene-butadiene ratios of about 1:3 to about 3:1), polyvinyl acetate (e.g., having GPC weight average molecular weight of about 2,000 to about 90,000), polyisoprene, polyethylene, vinyl acetate-vinyl laurate copolymer (e.g., having a vinyl laurate content of about 5% to about 50% by weight of the copolymer), and combinations thereof.

Natural elastomers may include natural rubber, such as smoked or liquid latex and guayule, as well as natural gums, such as crown gum, rosindinha, jelutong, lechi caspi, perillo, niger gutta, tunu, sorva, massaranduba balata, massaranduba chocolate, nispero, rosindinha, chicle, gutta percha, gutta kay, gutta hang kang, and combinations thereof. The selection of the synthetic elastomer and natural elastomer concentrations vary depending on whether the chewing gum in which the base is used is adhesive or conventional, bubble gum or regular gum, as discussed below. Preferred natural elastomers include jelutong, chicle, sorva and massaranduba balata.

Additional useful polymers include crosslinked polyvinyl pyrrolidone, polymethylmethacrylate; copolymers of lactic acid, polyhydroxyalkanoates, plasticized ethylcellulose, polyvinyl acetatephthalate and combinations thereof.

The chewing gum base may include amounts of conventional additives selected from the group consisting of sweetening agents (sweeteners), plasticizers, softeners, emulsifiers, waxes, fillers, bulking agents (carriers, extenders, bulk sweeteners), mineral adjuvants, flavoring agents (flavors, flavorings), coloring agents (colorants, colorings), antioxidants, acidulants, thickeners, and medicaments, and combinations thereof. Some of these additives may serve more than one purpose. For example, in sugarless gum compositions, a sweetener, such as maltitol or other sugar alcohol, may also function as a bulking agent.

The gum base may contain elastomer solvents to aid in softening the elastomer component including: synthetic rosins such as terpenes known in the art; and natural rosins such as rosin esters or partially hydrogenated rosins known in the art such as glycerol esters of polymerized rosin, glycerol esters of partially dimerized rosin, glycerol esters of rosin, pentaerythritol esters of partially hydrogenated rosin, methyl and partially hydrogenated methyl esters of rosin, pentaerythritol esters of rosin. Examples of elastomer solvents suitable for use herein may include the pentaerythritol ester of partially hydrogenated wood and gum rosin, the pentaerythritol ester of wood and gum rosin, the glycerol ester of wood rosin, the glycerol ester of partially dimerized wood and gum rosin, the glycerol ester of polymerized wood and gum rosin, the glycerol ester of tall oil rosin, the glycerol ester of wood and gum rosin and the partially hydrogenated wood and gum rosin and the partially hydrogenated methyl ester of wood and rosin, and the like, and combinations thereof. Terpene resins may be derived from alpha beta and/or any suitable combinations of the foregoing and include, for instance, polymers of alpha-pinene or beta-pinene, methyl, glycerol and pentaerythritol esters of rosins and modified rosins and gums such as hydrogenated, dimerized and polymerized rosins, and combinations thereof. Combinations of natural and synthetic solvents are within the scope of the present disclosure. Selection of elastomer solvent may vary depending on the specific application. The gum base may suitably comprise from about 2 wt. % to about 15 wt. % or from about 5 wt. % to about 10 wt. % plasticizer.

The gum base may also include plasticizers or softeners to provide a variety of desirable textures and consistency properties. Because of the low molecular weight of these ingredients, the plasticizers and softeners are able to penetrate the fundamental structure of the gum base making it plastic and less viscous. Useful plasticizers and softeners include lanolin, palmitic acid, oleic acid, stearic acid, sodium stearate, potassium stearate, glyceryl triacetate, lecithin, glyceryl monostearate, propylene glycol monostearate, acetylated monoglyceride, glycerine, and the like, and combinations thereof. Plastic polymers such as polyvinyl acetate, which behave somewhat as plasticizers, may also be included. Other plastic polymers that may be used include polyvinyl laurate, polyvinyl alcohol, and polyvinyl pyrrolidone. The gum base may comprise up to about 20 wt. %, from about 1 wt. % to about 15 wt. %, from about 5 wt. % to about 20 wt. %, or from about 10 wt. % to about 15 wt. % plasticizers and softeners.

Plasticizers may also include one or more hydrogenated vegetable oils such as, without limitation, soybean oil and cottonseed oil. In some aspects, such plasticizers may provide the gum base texture and soft chew characteristics. The gum base may suitably comprise from about 5 wt. % to about 15 wt. % or from about 5 wt. % to about 13 wt. % of such plasticizers and softeners. Anhydrous glycerin may also be employed as a softening agent. Glycerin has a sweetness of about 60% of that of cane sugar and may also function as a sweetener

In some aspects of the disclosure, the gum base may optionally include a low melting wax to both soften the polymeric elastomer mixture and improve the elasticity of the gum base. Preferred waxes have a melting point below 60° C., such as from about 45° C. to about 55° C. Waxes include natural and synthetic waxes, such as, for instance, hydrogenated vegetable oils, petroleum waxes (e.g., polyurethane waxes), polyethylene waxes, paraffin waxes, microcrystalline waxes, fatty waxes, sorbitan monostearate, tallow, propylene glycol, and combinations thereof. The gum base may comprise from about 6 wt. % to about 10 wt. % or from about 7 wt. % to about 9% low melting wax.

In some other aspects of the disclosure, the gum base may optionally comprise a wax having a higher melting point than the low melting wax. Examples include, without limitation, beeswax, vegetable wax, candelilla wax, carnuba wax, petroleum waxes and combinations thereof. Typically the gum base may comprise up to 5 wt. % of such a high melting wax.

Aqueous sweetener solutions such as those containing sorbitol, hydrogenated starch hydrolysates, corn syrup and combinations thereof, may also function as softeners and binding agents in chewing gum.

In some aspects of the disclosure, the gum base may comprise one or more emulsifiers to promote dispersion of the immiscible components into a single stabilized system. Suitable emulsifiers include, without limitation, tallow, hydrogenated tallow, hydrogenated and partially hydrogenated vegetable oils, cocoa butter, glycerol monostearate, glycerol triacetate, lecithin, mono and triglycerides, acetylated monoglycerides, fatty acids (for example, stearic, palmitic, oleic and linoleic acids), lecithin, fatty acid monoglycerides, diglycerides, and combinations thereof. The gum base may comprise from about 2 wt. % to about 15 wt. % or from about 5 wt. % to about 10 wt. % emulsifier.

In some aspects of the disclosure, the gum base may comprise fillers/texturizers. Suitable fillers/texturizers include, without limitation: calcium carbonate; magnesium carbonate; alumina; ground limestone; clay; aluminum hydroxide; aluminum silicate; magnesium silicate; talc; mono-, di- and tri-phosphate (e.g., tricalcium phosphate and dicalcium phosphate); calcium sulfate; titanium dioxide; cellulose polymers; and combinations thereof. Titanium dioxide may also function as a colorant. The gum base may suitably comprise up to 40 wt. % or up to 30 wt. % filler/texturizer.

The gum base may optionally comprise one or more anti-oxidant compounds other than rutin/isoquercitrin. Examples of such anti-oxidants include, without limitation, as butylated hydroxytoluene (BHT), butylated hydroxyanisole (BHA), propyl gallate, and combinations thereof.

The water soluble portion may suitably comprise one or more of include bulk sweeteners, high intensity sweeteners, flavoring agents, softeners, emulsifiers, colors, acidulants, fillers, secondary antioxidants (i.e., other than rutin/isoquercitrin anti-oxidants), and other components that provide desired attributes.

Bulk sweeteners include both sugar and sugarless components. Bulk sweeteners include, but are not limited to: monosaccharides, disaccharides, polysaccharides, sugar alcohols, and combinations thereof; randomly bonded glucose polymers such as polydextrose (available under the trade name LITESSE manufactured by Danisco Sweeteners, Terre Haute, Ind.); isomalt (a racemic mixture of alpha-D-glucopyranosyl-1,6-mannitol and alpha-D-glucopyranosyl-1,6-sorbitol manufactured under the trade name PALATINIT by Suddeutsche Zucker); maltodextrins; hydrogenated starch hydrolysates; hydrogenated hexoses; and hydrogenated disaccharides. Examples of sugar sweeteners include, without limitation, sucrose, glucose (dextrose), maltose, dextrin, invert sugar, fructose (levulose), galactose, xylose, ribulose, corn syrup solids, partially hydrolyzed starch, and combinations thereof. Examples of sugarless sweeteners include, without limitation, sugar alcohols such as sorbitol, erythritol, mannitol, xylitol, galactitol, hydrogenated starch hydrolysates, maltitol, and combinations thereof. Chewing gum typically comprises from about 5 wt. % to about 95 wt. %, from about 20 wt. % to about 80 wt. %, or from about 30 wt. % to about 6 wt. % bulk sweeter.

Suitable hydrogenated starch hydrolysates include those disclosed in U.S. Pat. Nos. 3,356,811 and 4,279,931 (both incorporated by reference herein), and various hydrogenated glucose syrups and/or powders which contain sorbitol, hydrogenated disaccharides, hydrogenated higher polysaccharides, and combinations thereof. Hydrogenated starch hydrolysates are primarily prepared by the controlled catalytic hydrogenation of corn syrups. The resulting hydrogenated starch hydrolysates are mixtures of monomeric, dimeric, and polymeric saccharides. The ratios of these different saccharides give different hydrogenated starch hydrolysates different properties. Mixtures of hydrogenated starch hydrolysates, such as LYCASIN, a commercially available product manufactured by Roquette Freres of France, and HYSTAR, a commercially available product manufactured by Lonza, Inc., of Fairlawn, N.J., are also useful.

In some aspects of the disclosure, the water soluble portion may comprise high intensity artificial sweeteners that optionally may be used as the sole sweetener or may be used in combination with the sweeteners disclosed above. Examples of high intensity artificial sweeteners include, without limitation, sucralose, aspartame, acesulfame K, neopentyl-NAPM derivatives such as neotame, salts of acesulfame, altitame, saccharin and its salts, cyclamic acid and its salts, glycyrrhizinate, dihydrochalcones, thaumatin, monellin, and combinations thereof. In order to provide longer lasting sweetness and flavor perception, it may be desirable to encapsulate or otherwise control the release of at least a portion of the artificial sweetener. Such techniques for achieving the desired release characteristics are known in the art and include wet granulation, wax granulation, spray drying, spray chilling, fluid bed coating, coacervation, and fiber extension.

Combinations of sugar, sugarless and high intensity artificial sweeteners may be used in chewing gum. Additionally, some softeners, such as aqueous sugar or alditol solutions, may also provide additional sweetness.

If a low calorie gum is desired, a low caloric bulking agent can be used. Some non-limiting examples of low caloric bulking agents include: polydextrose; raftilose, raftilin; fructooligosaccharides (NutraFlora); Palatinose oligosaccharide; guar gum hydrolysate (Sun Fiber); or indigestible dextrin (Fibersol). Other low calorie bulking agents known in the art can optionally be used.

Acidulants may suitably comprise one or more food grade acids. Examples of such acids include, but are not limited to, fumaric acid, malic acid, tartaric acid, citric acid, lactic acid, ascorbic acid, or mixtures of same. In some aspects, the acidulants are acid salts, e.g., sodium and/or potassium salts, such as sodium fumarate, sodium malate, sodium tartrate, sodium citrate, sodium lactate, and sodium ascorbate.

The plasticizers, softening agents, mineral adjuvants, waxes and antioxidants discussed above, as being suitable for use in the gum base, may also be used in the water soluble portion of the chewing gum composition. Examples of other conventional additives which may be used include emulsifiers, such as lecithin and glyceryl monostearate, thickeners, used alone or in combination with other softeners, such as methyl cellulose, alginates, carrageenan, xanthan gum, gelatin, carob, tragacanth, locust bean gum, pectin, alginates, galactomannans such as guar gum, carob bean gum, glucomannan, gelatin, starch, starch derivatives, dextrins and cellulose derivatives such as carboxy methyl cellulose, acidulants such as malic acid, adipic acid, citric acid, tartaric acid, fumaric acid, and combinations thereof, and fillers.

Flavoring agents suitable for use with any of the various aspects of the present disclosure include natural and artificial flavors known in the art. Such flavorings may be chosen from, without limitation, synthetic flavor oils and flavoring aromatics and/or oils, oleoresins and extracts derived from plants, leaves, flowers, fruits, and combinations thereof. The amount of flavoring agent employed herein may be a matter of preference subject to such factors as the type of final chewing gum composition, the individual flavor, the gum base employed, and the strength of flavor desired. Thus, the amount of flavoring may be varied in order to obtain the result desired in the final product and such variations are within the capabilities of those skilled in the art without the need for undue experimentation. Chewing gum compositions may suitably comprise from about 0.1 wt. % to about 15% wt. %, from about 0.02 wt. % to about 5 wt. %, from about 0.1 wt. % to about 3 wt. % or from about 1 wt. % to about 2 wt. % flavoring agent.

In some aspects of the disclosure, the flavoring agent may be employed in either liquid form and/or dried form. Alternatively, the flavoring agent may be absorbed onto water soluble materials, such as cellulose, starch, sugar, maltodextrin, gum arabic and so forth or may be encapsulated. In some aspects, the flavoring agents may be used in many distinct physical forms well-known in the art to provide an initial burst of flavor and/or a prolonged sensation of flavor. Without being limited thereto, such physical forms include free forms, such as spray dried, powdered, beaded forms, encapsulated forms, and combinations thereof.

Non-limiting examples of suitable flavor oils include spearmint oil, cinnamon oil, oil of wintergreen (methyl salicylate), peppermint oil, clove oil, bay oil, anise oil, eucalyptus oil, thyme oil, cedar leaf oil, oil of nutmeg, allspice, oil of sage, mace, oil of bitter almonds, and cassia oil. Non-limiting examples of artificial, natural and synthetic fruit flavors include vanilla, citrus oils (e.g., lemon, orange, lime and grapefruit), and fruit essences (e.g., apple, pear, peach, grape, strawberry, raspberry, cherry, plum, pineapple, and apricot). The flavoring agents may be used in liquid or solid form and may be used individually or in admixture. Commonly used flavors include mints such as peppermint, menthol, spearmint, artificial vanilla, cinnamon derivatives, and various fruit flavors, whether employed individually or in admixture.

Other useful flavorings include aldehydes and esters such as cinnamyl acetate, cinnamaldehyde, citral diethylacetal, dihydrocarvyl acetate, eugenyl formate, p-methylamisol, and so forth. Generally any flavoring or food additive such as those described in Chemicals Used in Food Processing, publication 1274, pages 63-258, by the National Academy of Sciences, may be used. This may include natural as well as synthetic flavors. Further examples of aldehyde flavorings including, but not limited to, acetaldehyde (apple), benzaldehyde (cherry, almond), anisic aldehyde (licorice, anise), cinnamic aldehyde (cinnamon), citral, i.e., alpha-citral (lemon, lime), neral, i.e., beta-citral (lemon, lime), decanal (orange, lemon), ethyl vanillin (vanilla, cream), heliotrope, i.e., piperonal (vanilla, cream), vanillin (vanilla, cream), alpha-amyl cinnamaldehyde (spicy fruity flavors), butyraldehyde (butter, cheese), valeraldehyde (butter, cheese), citronella) (modifies, many types), decanal (citrus fruits), aldehyde C-8 (citrus fruits), aldehyde C-9 (citrus fruits), aldehyde C-12 (citrus fruits), 2-ethyl butyraldehyde (berry fruits), hexenal, i.e., trans-2 (berry fruits), tolyl aldehyde (cherry, almond), veratraldehyde (vanilla), 2,6-dimethyl-5-heptenal, i.e., melonal (melon), 2,6-dimethyloctanal (green fruit), and 2-dodecenal (citrus, mandarin), cherry, grape, strawberry shortcake, and combinations thereof.

In some aspects of the disclosure, the flavoring agent may optionally comprise one or more cooling agents. Examples of suitable cooling agents include, without limitation, menthol, xylitol, menthane, menthone, ketals, menthone ketals, menthone glycerol ketals, substituted p-menthanes, acyclic carboxamides, substituted cyclohexanamides, substituted cyclohaxane carboxamides, substituted ureas and sulfonamides, substituted menthanols, hydroxymethyl and hydroxymethyl derivatives of p-menthane, 2-mercapto-cyclo-decanone, 2-isoprpanyl-5-methylcyclohexanol, hydroxycarboxylic acids with 2-6 carbon atoms, cyclohexanamides, methyl acetate, menthyl lactate, menthyl salicylate, N,2,3-trimethyl-2-isopropyl butanamide (WS-23), N-ethyl-p-menthane-3-carboxamide (WS-3), menthyl succinate, 3,1-menthoxypropane 1,2-diol, among others. Cooling agents may suitably be formulated in an outer gum coating composition or in the chewing gum composition per se. Outer coating composition compositions typically comprise form about 0.01 wt. % to about 1 wt. % cooling agent. When formulated in chewing gum per se, the cooling agent may suitably comprise from about 0.001 wt. % to about 10 wt. % by weight of the chewing gum.

In some other aspects of the disclosure, the flavoring agent may optionally comprise one or more warming components to provide the sensory signal of warming to the user and may further function to enhance the perception of flavors, sweeteners and other organoleptic components. Examples of suitable warming components include, without limitation, vanillyl alcohol n-butylether (TK-1000) supplied by Takasago Perfumary Company Limited, Tokyo, Japan, vanillyl alcohol n-propylether, vanillyl alcohol isopropylether, vanillyl alcohol isobutylether, vanillyl alcohol n-aminoether, vanillyl alcohol isoamyleather, vanillyl alcohol n-hexyleather, vanillyl alcohol methylether, vanillyl alcohol ethyleather, gingerol, shogaol, paradol, zingerone, capsaicin, dihydrocapsaicin, nordihydrocapsaicin, homocapsaicin, homodihydrocapsaicin, ethanol, isopropyl alcohol, iso-amylalcohol, benzyl alcohol, glycerine, and combinations thereof.

Optionally, the chewing gum of the present disclosure may comprise additional breath freshening, anti-microbial or oral health ingredients. Food acceptable metallic salts may be suitably selected from zinc and copper salts of gluconic acid, zinc and copper salts of lactic acid, zinc and copper salts of acetic acid, zinc and copper salts of citric acid, and combinations thereof.

Optionally, the chewing gum of the present disclosure may comprise dental health ingredients such as fluoride salts, phosphate salts, proteolytic enzymes, lipids, anti-microbials, calcium, electrolytes, protein additives, dental abrasives and combinations thereof.

In still other aspects of the disclosure, the flavoring agent may optionally comprise as breath freshening agent having odor-controlling properties. Examples include essential oils and flavor components such as peppermint, methyl salicylate, thymol, eucalyptol, cinnamic aldehyde, polyphosphate, pyrophosphate and combinations thereof. The breath freshening agents may be further encapsulated.

Coloring agents in addition to naturally derived food colorant may be used in amounts effective to produce or enhance the desired color. The coloring agents may include pigments which may be incorporated in amounts up to about 6 wt. %, by weight of the gum composition. For example, the chewing gum composition may comprise up to about 2 wt. % or up to about 1 wt. % titanium dioxide. The colorants may also include natural food colors and dyes suitable for food, drug and cosmetic applications. These colorants are known as F.D.& C. dyes and lakes. The materials acceptable for the foregoing uses are preferably water-soluble. Illustrative nonlimiting examples include: the indigoid dye known as F.D.& C. Blue No. 2, which is the disodium salt of 5,5-indigotindisulfonic acid; and F.D.& C. Green No. 1 that comprises a triphenylmethane dye and is the monosodium salt of 4-[4-(N-ethyl-p-sulfoniumbenzylamino) diphenylmethylene]-[1-(N-ethyl-N-p-sulfoniumbenzyl)-delta-2,5-cyclohexadieneimine]. A full recitation of all F.D.& C. colorants and their corresponding chemical structures may be found in the Kirk-Othmer Encyclopedia of Chemical Technology, 3rd Edition, in volume 5 at pages 857-884.

### IV. PREPARATION OF CHEWING GUM

In general, chewing gum is manufactured by sequentially adding the various chewing gum ingredients to a commercially available mixer known in the art.

In some aspects, the ingredients are mixed by first melting the gum base and adding it to the running mixer. The base may also be melted in the mixer itself. Color or emulsifiers may also be added at this time. A softener such as glycerin may also be added at this time, along with syrup and a portion of the bulking agent. Further parts of the bulking agent are added to the mixer. Flavoring agents are typically added with the final portion of the bulking agent. Other optional ingredients are added to the batch in a typical fashion, well known to those of ordinary skill in the art. The entire mixing procedure typically takes from five to fifteen minutes, but longer mixing times may sometimes be required. Those skilled in the art will recognize that many variations of the above described procedure may be followed.

In some aspects of the disclosure, chewing gum base and chewing gum product may be manufactured conventionally using separate mixers and different mixing technologies. In some aspects, such separate processing is used because the preferred conditions for manufacturing gum base (e.g., relatively high temperature, relatively high viscosity, relatively long mixing times, relatively high mixing shear, etc.) and for manufacturing chewing gum from gum base and other ingredients such as sweeteners and flavors are different. In particular, chewing gum base manufacturing involves the dispersive (often high shear) mixing of difficult-to-blend ingredients, such as elastomer, filler, elastomer plasticizer, base softeners/emulsifiers, and sometimes waxes. Such a process typically requires long mixing times. Other chewing gum components such as naturally derived food colorant, isoquercitrin (including enzymatically modified isoquercitrin), softeners, bulk sweeteners, high intensity sweeteners and flavoring agents may be degraded under some process conditions suitable for chewing gum base manufacture and are more suitably formulated using comparably generally lower shear and shorter mixing times required to produce the chewing gum product.

After the ingredients have been thoroughly mixed, the gum mass is discharged from the mixer and shaped into the desired form such as by rolling into sheets and cutting into sticks, extruding into chunks or casting into pellets, which are then coated or panned.

Chewing gums of the present disclosure may be optionally coated. Pellet or ball gum is prepared as conventional chewing gum, but formed into pellets that are pillow- or ball-shaped. The pellets/balls can be then sugar coated or panned by conventional panning techniques to make a unique sugar coated pellet gum. Conventional panning procedures generally coat with sucrose, but recent advances in panning have allowed the use of other carbohydrate materials to be used in the place of sucrose.

Coating compositions are generally formulated as a syrup and comprise dextrose, maltose, palatinose, xylitol, lactitol, hydrogenated isomaltulose, and other new alditols and combinations thereof. These materials may be blended with panning modifiers including, but not limited to, gum arabic, maltodextrins, corn syrup, gelatin, cellulose type materials like carboxymethyl cellulose or hydroxymethyl cellulose, starch and modified starches, vegetable gums like alginates, locust bean gum, guar gum, and gum tragacanth, insoluble carbonates like calcium carbonate or magnesium carbonate and talc. Antitack agents may also be added as panning modifiers which allow the use of a variety of carbohydrates and sugar alcohols to be used for coated gum products. In some embodiments, the natural colorant and the rutin/isoquercitrin anti-oxidant can be added to a hot sugar solution prepared for sugar panning to produce a colored coating, or can be combined with a sweetener and used in conventional panning procedures.

Other ingredients may be included in the compositions including, for instance and without limitation, essential oils, cooling agents, heating agents, flavors, and combinations thereof. Flavoring agents contemplated by the present disclosure, include those commonly known in the art such as essential oils, synthetic flavors, and combinations thereof, including but are not limited to, oils derived from plants and fruits such as citrus oils, fruit essences, peppermint oil, spearmint oil, other mint oils, clove oil, oil of wintergreen, anise and the like. The coating syrup may suitable comprise from about 0.1 wt. % to about 1.5 wt. % flavoring agent or from about 0.5 wt. % to about 1 wt. % flavoring agent.

Dispersing agents may optionally be added to coating syrup for the purpose of whitening and tack reduction. Dispersing agents contemplated by the present disclosure to be employed in the coating syrup include titanium dioxide, talc, or any other antistick compound known in the art. Coating syrups may suitably comprise from about 0.1 wt. % to about 1 wt. % or from about 0.3 wt. % to about 0.6 wt. % dispersing agent.

In addition to the naturally derived food colorants provided herein, additional coloring agents may be incorporated into the coating syrup. Such additional coloring agents may be added directly to the coating syrup in dye or lake form. Coloring agents contemplated by the present disclosure include food quality dyes.

In some film coating aspects, film formers and/or binding agents may be added to the coating syrup. Examples of film formers include, without limitation, methylcellulose, carboxymethyl cellulose, ethyl cellulose, hydroxyethyl cellulose, and combinations thereof. Examples of binding agents include, without limitation, gum arabic, gum talha, gelatin, vegetable gums, and combinations thereof. Coating syrup typically comprises from about 0.5 wt. % to about 10 wt. % binding agent.

### V. CONFECTIONARY FORMULATIONS

In accordance with yet another aspect of the disclosure, a confectionary formulation is provided with an effective amount of a stabilized naturally derived food colorant. Confectionery products for this disclosure may be, for instance and without limitation, hard candies, chewy candies, coated chewy center candies and tableted candies. By way of example, the sugar-based hard candy primarily comprises corn syrup and sugar sweetener and typically comprise from about 1 wt. % to about 5 wt. % moisture. In sugarless candy, some or all of the corn syrup and sugar may be replaced with sugarless sweeteners as described herein. In appearance, these types of candies are solid, but they are actually super-cooled liquids, which are far below their melting points. Different types of hard candies are typical. Glass types are usually clear or made opaque with dyes; and grained types, which are always opaque.

The continuous process for making the deposited glass types with a sweetener base are as follows. Sweetener (e.g., corn syrup) is spread over a cylinder heated by high pressure steam. Rapid heat exchange causes the water in the syrup to evaporate. The cooked syrup is discharged, naturally derived food colorant, isoquercitrin and flavors are added. The syrup is cooled and deposited onto a stainless steel conveyor. The syrup can be conveyed directly to hoppers which then discharge directly into molds.

The candy is conveyed to batch rollers where the batch is shaped and sized. The candy enters a former where the individual pieces are formed into the desired shape (e.g., discs, balls, barrels, etc.). The candy is then cooled, wrapped and packaged.

For grained types of candy, water and sweetener are combined with other ingredients, and cooked at high temperatures about 140° C. to about 155° C., causing the water to turn to steam. The product is transferred to a cooling wheel, where it is collected in batches, placed in a pulling machine to aerate the product, and the flavor is added. In some such aspects, the naturally derived food colorant and rutin/isoquercitrin antioxidant are added with the flavoring. The candy is transferred to batch rollers where it is shaped and sized. The candy is cooled at a relative humidity of from about 25% to about 50%, such as 35%, and enters a rotating drum where it is coated with a fine sugar. The candy is then conveyed to the graining room and held at a fixed temperature and humidity for a curing time, such as for from about 2 hours to about 8 hours, such as about 4 hours, at from about 20° C. to about 40° C., such as about 30° C. and at from about 50% to about 70% relative humidity, such as about 60%. The entrapped air and moisture causes the product to grain.

In some embodiments, the natural colorant and the rutin/isoquercitrin anti-oxidant can be added to a sugar or sugar-free solution, and applied to the surface of confectionary compositions by conventional panning procedures herein.

### VI. EVALUATION OF COLOR STABILITY

Various methods are suitable for evaluation of color stability of the edible food compositions of the present disclosure. Some of the testing protocols are detailed in Table 2 below.

TABLE 2

| | Temperature and Humidity | Sampling |
|---|---|---|
| Test Type | Storage Conditions | Frequency |
| Real time “ambient aging” | 23° C. and 50% RH light | Monthly, |
| | | until product |
| | | failure |
| Accelerated “hot high | 35° C. and 85% RH dark | Weekly for |
| humid aging” | | 8 weeks |
| Accelerated “hot low humid | 30° C. and 70% RH dark | Weekly for |
| aging” | | 8 weeks |
| Accelerated “Very-hot effect | 45° C. and 33% RH dark | Day 0, 3, 5, |
| of heat on accelerating” | | 7, 10, 14 |
| | | for 2 weeks |
| Accelerated - Eliminate | 23° C. and 50% RH dark | Weekly for |
| oxidation effects (compare to | | 8 weeks |
| 23/50 dark) | | |
| ICH-Q1B (fast light test - | 23° C. and 50% RH light | Hourly for |
| industry standard) | | 6 hours |

Stability evaluation may suitably done by comparing the color of compositions of the present disclosure versus a similarly formulated control composition differing with respect to the absence of an anti-oxidant. Evaluation may be done visually and/or by spectrophotometric methods known in the art such as by measurement of absorption or transmittance light wavelength generally corresponding to the color under evaluation. In certain embodiments, the color stability is determined visually by comparison of color intensity or color shift, wherein instability is indicated by a reduction in color intensity, by a color shift, or by a combination thereof.

Suitable instruments for evaluating stability include colorimeters and spectrophotometers. The HunterLab L*a*b* color measurement scale (also referred to as CIELAB) is known in the art as a method for measuring color and is widely used in the food industry. L* indicates lightness and a* and b* are the chromaticity coordinates. Color differences between samples under evaluation may be measured using a color spectrophotometer (UltraScan®VIS, Hunter Lab, Reston, Va.). The results are typically presented in a chromaticity diagram where a* and b* indicate color directions: +a* is the red direction, −a* is the green direction, +b* is the yellow direction, and −b* is the blue direction. The center is achromatic; as the a* and b* values increase and the point moves out from the center, the saturation of the color increases.

In some aspects, photostability (color) testing may be done according to method known in the art such as using a photostability chamber in accordance with the International Conference on Harmonization of Technical Requirements for Registration of Pharmaceuticals for Human Use, Stability Testing: Photostability of New Drugs and Substances and Products, Q1B (“ICH Q1B”) photostability protocol. Photostability chambers are available commercially, such as from Caron Products, Marietta, Ohio.

### VII. EXAMPLES

The disclosure may be further illustrated with reference to the following, non-limiting Examples.

### Example 1: Naturally Derived Food Colorant Stabilized with Enzymatically Modified Isoquercitrin

Sugarless chewing gum compositions were prepared containing the components detailed in Table 3 below wherein “Bulk” refers to a polyol bulking agent, “Base” refers to an elastomeric gum base, “EHPW” refers to encapsulated high potency sweetener, “Polyol” refers to polyol syrup, “NHPW” refers to neat high potency sweetener, “Black carrot” or “BC” refers to black carrot natural (non-artificial) color, “Red beet” refers to red beet natural (non-artificial) color, “Fruit” refers to fruit punch flavor, “Mint” refers to mint flavor, and “EMIQ” refers to enzymatically modified isoquercitrin (from San Ei Gen).

TABLE 3

| | Control | | | Control | | |
|---|---|---|---|---|---|---|
| | (Gum 1) | Gum 2 | Gum 3 | (Gum 4) | Gum 5 | Gum 6 |
| | Wt. % | | | | | |
| | Fruit | Fruit punch/ | Fruit punch | | Mint/beet/ | Mint/beet/ |
| | punch/BC | BC/EMIQ 0.5% | BC/EMIQ 1% | Mint/beet | EMIQ 0.5% | EMIQ 1% |
| Bulk | 38.9 | 38.4 | 37.9 | 38.6 | 38.1 | 37.6 |
| Base | 27.3 | 27.3 | 27.3 | 31.0 | 31.0 | 31.0 |
| Polyol | 28.1 | 28.1 | 28.1 | 24.5 | 24.5 | 24.5 |
| EHPS | 1.4 | 1.4 | 1.4 | 1.3 | 1.3 | 1.3 |
| NHPS | 0.12 | 0.12 | 0.12 | 1.1 | 1.1 | 1.1 |
| Acid | 2.0 | 2.0 | 2.0 | — | — | — |
| Water | — | — | — | 0.15 | 0.15 | 0.15 |
| Salt | — | — | — | 0.1 | 0.1 | 0.1 |
| solution | | | | | | |
| Black | 0.6 | 0.6 | 0.6 | — | — | — |
| carrot | | | | | | |
| Red beet | | | | 0.6 | 0.6 | 0.6 |
| Fruit | 1.58 | 1.58 | 1.58 | — | — | — |
| Mint | — | — | — | 2.65 | 2.65 | 2.65 |
| EMIQ | — | 0.5 | 1.0 | — | 0.5 | 1.0 |
| TOTAL | 100.0 | 100.0 | 100.0 | 100.0 | 100.0 | 100.0 |

The sugarless gum compositions were prepared by adding the black carrot or red beet color on top of the combination of the gum base, polyol syrup and high potency sweeteners. The enzymatically modified isoquercitrin was then added on top of the black carrot or red beet color. The components were then admixed using mixing procedures known in the art.

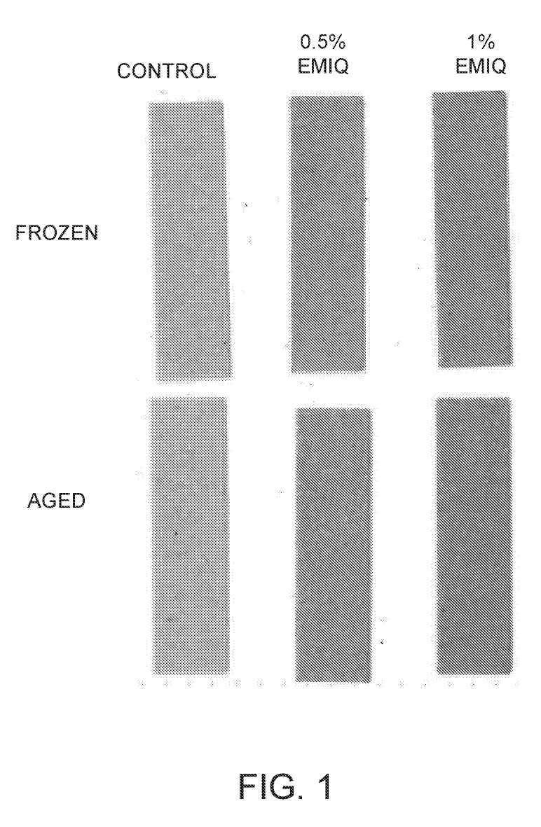

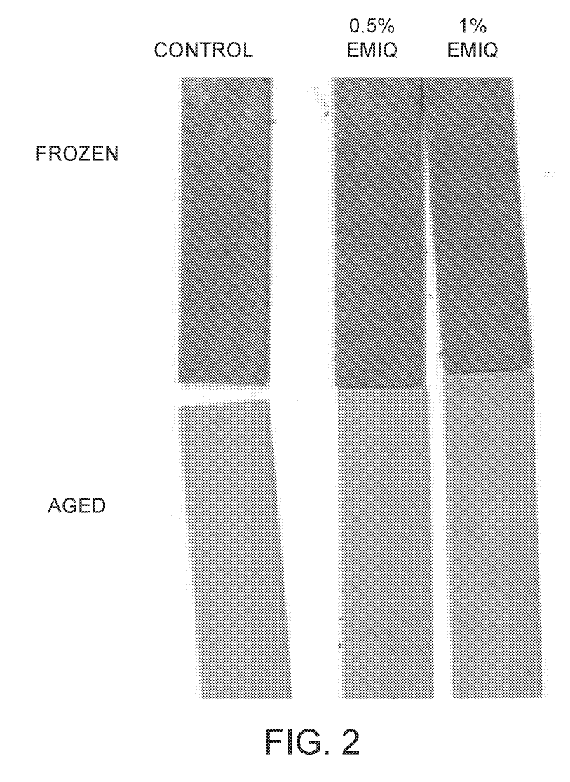

Stability testing was done using the following protocol. Duplicate samples for each of Gums 1 to 6 were collected. Each sample was placed in a high barrier overwrap bag. In an accelerated stability evaluation, a first set of bagged samples for gums 1 to 6 were placed in a freezer and a second set of bagged samples for gums 1 to 6 were stored at 45° C. and 33% relative humidity. For stability analysis, every other day for two weeks the frozen samples were brought to room temperature and evaluated visually versus the corresponding sample subjected to accelerated stability testing. The results are presented in FIG. 1 (for control gum 1 and gums 2 and 3) and FIG. 2 (for control gum 4 and gums 5 and 6).

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal languages of the claims.

With reference to the use of the words “comprise” or “comprises” or “comprising” in this patent application (including the claims), Applicants note that unless the context requires otherwise, those words are used on the basis and clear understanding that they are to be interpreted inclusively, rather than exclusively, and that Applicants intend each of those words to be so interpreted in construing this patent application, including the claims below. Furthermore, as used herein, reference to “a” or “an” means “one or more.” Throughout, the plural and singular should be treated as interchangeable, other than the indication of number.

1. An edible composition comprising:
(1) from about 0.0005 to about 3 percent by weight of a natural colorant; and
(2) from about 0.015 to about 0.15 percent by weight of enzymatically modified isoquercitrin anti-oxidant.

2. (canceled)

3. The composition of claim 1 wherein the natural colorant is selected from carotenoid, curcumin, anthocyanins, betanin, gardenia blue, gardenia yellow, chlorophyllins, phycocyanins and combinations thereof.

4. The composition of claim 3 wherein the natural colorant comprises black carrot, beet, and combinations thereof.

5. The composition of claim 1 characterized by the essential absence of poly- and oligo-saccharides.

6. The composition of claim 1 further comprising at least one acid.

7. The composition of claim 1, wherein the composition is a sugarless chewing gum.

8. (canceled)

9. An edible composition comprising:
(1) from about 0.0005 to about 3 percent by weight of a natural colorant; and
(2) from about 0.015 to about 0.15 percent by weight of enzymatically modified isoquercitrin anti-oxidant 1 wherein the color stability is enhanced as compared to a similarly formulated control composition differing with respect to the absence of an anti-oxidant, wherein the color stability is determined visually by comparison of color intensity, color shift, or by a combination thereof.

10. The composition of claim 9 wherein the composition and the control composition are each evaluated using at least one of the following protocols:
(1) storage at 23° C. and 50% relative humidity under light conditions and evaluated monthly until product failure;
(2) storage at 35° C. and 85% relative humidity under dark conditions and evaluated weekly for 8 weeks;
(3) storage at 30° C. and 70% relative humidity under dark conditions and evaluated weekly for 8 weeks;
(4) storage at 45° C. and 33% relative humidity under dark conditions and evaluated at days 0, 3, 5, 7, 10, 14;
(5) storage at 23° C. and 50% relative humidity under dark conditions and evaluated weekly for 8 weeks; and
(6) storage at 23° C. and 50% relative humidity under light conditions and evaluated weekly for 8 weeks.

11. The composition of claim 9 wherein the composition and the control composition are each evaluated according to the ICH Q1B photostability protocol.

12. (canceled)

13. (canceled)

14. (canceled)

15. The composition of claim 9 comprising:
(1) from about 0.0005 to about 3 percent by weight of the natural colorant; and
(2) from about 0.015 to about 0.15 percent by weight of the enzymatically modified isoquercitrin.

16. (canceled)

17. The composition of claim 9 wherein the natural colorant is selected from carotenoid, curcumin, anthocyanins, betanin, gardenia blue, gardenia yellow, chlorophyllins, phycocyanins and combinations thereof.

18. The composition of claim 9 wherein the natural colorant is selected from black carrot, beet, and combinations thereof.

19. The composition of claim 9 characterized by the essential absence of poly- and oligo-saccharides.

20. The composition of claim 9 further comprising at least one acid.

21. The composition of claim 9, wherein the composition is a sugarless chewing gum.

22. (canceled)

23. A method for preparing a sugarless chewing gum composition, the method comprising:
(1) forming a premix comprising a natural colorant and enzymatically modified isoquercitrin anti-oxidant;
(2) combining the premix with a water soluble bulk portion, a water-insoluble base portion, a sweetener portion, and a flavoring portion; and
(3) admixing the components to form the sugarless gum composition.

24. The method of claim 23 wherein the premix comprising the natural colorant and the enzymatically modified isoquercitrin anti-oxidant further comprises glyceryl, ethanol, or a combination thereof.

25. The method of claim 23 wherein the sugarless gum composition comprises:
(1) from about 0.0005 to about 3 percent by weight of the natural colorant; and
(2) from about 0.015 to about 0.15 percent by weight of the enzymatically modified isoquercitrin anti-oxidant.

26. The method of claim 25 wherein the weight ratio of the natural colorant to the enzymatically modified isoquercitrin anti-oxidant, such as enzymatically modified isoquercitrin, in the sugarless gum composition is about 200:1.

27. The method of claim 23 wherein the natural colorant is selected from carotenoid, curcumin, anthocyanins, betanin, gardenia blue, gardenia yellow, chlorophyllins, phycocyanins and combinations thereof.

28. The method of claim 23 wherein the natural colorant is selected from black carrot, and beet, and combinations thereof.

29. The method of claim 23 characterized by the essential absence of poly- and oligo-saccharides in the sugarless gum composition.

30. The method of claim 23 wherein the sugarless gum composition further comprises at least one acid.

31. The method of claim 23 wherein the color stability of the sugarless gum composition is enhanced as compared to a similarly formulated control composition differing with respect to the absence of an anti-oxidant, wherein the color stability is determined visually by comparison of color intensity or color shift wherein instability is indicated by a reduction in color intensity, by a color shift, or by a combination thereof.

32. (canceled)
